(19) United States
(12) Patent Application Publication
(10) Pub. No.: US 2017/0017672 A1
(43) Pub. Date: Jan. 19, 2017

(54) ACCESSING SEARCH RESULTS IN OFFLINE MODE

(71) Applicant: Microsoft Technology Licensing, LLC, Redmond, WA (US)

(72) Inventors: XIAODONG FAN, Bellevue, WA (US); SHRUTI MALUGU, Issaquah, WA (US); RICHARD QIAN, Redmond, WA (US); PRATEEK TIWARI, Sammamish, WA (US); MARCELO DE BARROS, Redmond, WA (US)

(21) Appl. No.: 14/799,406

(22) Filed: Jul. 14, 2015

(51) Int. Cl. G06F 17/30

(52) U.S. Cl. CPC G06F 17/30312; G06F 17/30867; G06F 17/30554; G06F 17/30528

(57) ABSTRACT

Access to online search results is provided when a user device is offline. When a user search query is received while online, the search query is submitted to an online search engine. Search results received from the search engine are presented to the user, and the search query and search results are stored in a local data storage. When the search query is received while offline, the search results associated with the stored search query are retrieved from the local data storage and presented to the user.

### BACKGROUND

Mobile apps are becoming increasingly important as smartphone users rely more and more on mobile devices as a means of Internet access. Some mobile apps access online search engine APIs where search results are retrieved via a network from a remote server and displayed on the mobile device.

### SUMMARY

A high-level overview of various aspects of some embodiments of the invention is provided here for that reason, to provide an overview of the disclosure and to introduce a selection of concepts that are further described below in the detailed-description section below. This summary is not intended to identify key features or essential features of the claimed subject matter, nor is it intended to be used as an aid in isolation to determine the scope of the claimed subject matter.

In brief and at a high level, this disclosure describes, among other things, ways to provide access to online search results when a user device is in offline mode. Search queries and associated search results received while online are stored in a persistent local storage that is accessible offline. When a user submits a stored search query while offline, the associated search results are retrieved from the local storage and presented to the user.

### BRIEF DESCRIPTION OF THE SEVERAL VIEWS OF THE DRAWINGS

Some illustrative embodiments of the present invention are described in detail below with reference to the attached drawing figures, and wherein:

FIG. 1 depicts a system for accessing search results in an offline mode in accordance with an embodiment of the present invention;

FIG. 2 depicts a method for accessing search results in an offline mode in accordance with an embodiment of the present invention; and

FIG. 3 depicts an exemplary operating environment suitable for implementing an embodiment of the present invention.

### DETAILED DESCRIPTION

The subject matter of select embodiments of the present invention is described with specificity herein to meet statutory requirements. But the description itself is not intended to define what we regard as our invention, which is what the claims do. The claimed subject matter might be embodied in other ways to include different steps or combinations of steps similar to the ones described in this document, in conjunction with other present or future technologies. Terms should not be interpreted as implying any particular order among or between various steps herein disclosed unless and except when the order of individual steps is explicitly described.

As used herein, “online” includes a state of being communicatively connected to, with, and/or accessible by, a network, such as the Internet or other type of communication network. Thus, when a mobile device is online, it may communicate with other online devices, such as a server, among others. Online storage includes storage that is accessible via a network. As one example, online storage may refer to cloud storage or storage of data on a server that is accessible online, i.e., when a network connection is available. “Offline” includes a state of not being connected to, or accessible by, such a network. Offline storage includes storage that may be accessed without a network connection. Offline storage may also be referred to as local storage. As one example, a mobile device or other type of computing device may include offline, or local, storage, e.g., a memory device, which is directly accessible by the mobile/computing device.

Mobile device users increasingly rely on their mobile devices as a means of accessing online information, whether by Wi-Fi, cellular access, or other type of network access. A variety of mobile apps utilize search engine APIs or similar functions to enable a user to locate desired information on a network, such as the Internet. However, such applications are typically of little use if the network connection is lost, since no information can then be obtained from the network. Network connectivity may be lost in many ways, such as by traveling to a foreign country, traveling out of range of a Wi-Fi network, traveling out of range of a cellular network, and so forth. Some embodiments of the present invention enable a user to access previously-obtained search results while in an offline mode.

Mobile apps on phones typically have access to persistent data storage, i.e., storage that persists after an app has terminated, and which remains accessible to the app when the app is restarted. For example, iOS devices provide Core Data, which is a persistent relational database. Some types of devices may provide a persistent flat-file storage. In an embodiment, a search app utilizes local storage that is accessible when offline, such as Core Data, as a persistent cache mechanism to maintain accessibility of previously-obtained search results.

In an embodiment, a search query received from a user is converted to an API call in the form of a URL and submitted to a search API. The output received from the search API in response to the search query may be (a) a well-formed structured content such as a JavaScript Object Notation (JSON) payload returned by the search engine server, or (b) an unstructured, potentially complex, Web page containing any or all of HTML, JavaScript, Ajax, multiple images, videos, and so forth. For example, the Bing API provides a JSON interface which accepts search requests in URL format and returns the search results payload in JSON format. JSON is a human-readable format for structuring data which is typically used to transmit data between a server and client-side application, as an alternative to XML. Embodiments of the invention are not limited to using JSON format. Some embodiments of the invention may receive search results from a search engine in XML format or other type of structured format.

In the case of (a), the search app may save the key/value pair <URL, payload> locally on a mobile device (using the persistent storage), where “URL” is the submitted search query formulated as a URL, and “payload” is the returned search result. In the case of (b), the apps may save the key/value pair <URL, image screenshot of the rendered page> locally on a mobile device (again, using the persistent storage). In an offline mode, users can access either content that came from the search engine servers (a), or any content from the web (b) which was saved as an image screenshot of the rendered page. The cache is limited in size, and in an embodiment is set as a percentage of the free space on the mobile device. The cache may be managed on a least-recently-used (LRU) basis. For example, each cache entry may have an access date associated with it indicating the last date and/or time when the entry was accessed, e.g., added, updated, and/or viewed by a user. When a key/value pair <URL, content> is accessed online and is either added to the cache or updated to an existing entry, the size of the cache is determined and, if necessary, one or more entries in the cache having the oldest access date are deleted to maintain the size of the cache within the prescribed limit.

In an embodiment, relationships between cache entries are not stored explicitly. For example, a JSON record received from a search engine may include the list of search results generated by the search engine. A particular search result item may include a URL pointing to an object such as an image. The JSON data will be stored, including the URL pointing to the image. The image will also be retrieved and stored as a separate entry in association with its URL. However, there may be no external or explicit indication stored that associates the JSON record with the stored image. The relationship is implicit in the data, that is, the JSON record includes the image URL, and the image can be identified within the cache based on its URL. Thus, when the mobile device is offline and the user selects the stored search query, the local cache is searched based on the search query URL, and the JSON record is located on that basis. The JSON record is fetched from the cache and rendered. When the image URL is encountered in the JSON record, the local cache is searched based on the image URL, and the image is located within the cache and fetched. Thus, the relationship between the JSON record and the image is implicit in the stored data, and there is no need to explicitly store the relationship.

As another example, a search result item may include a URL pointing to a Web page. The JSON data will be stored, including the URL pointing to the Web page. If the user selects that search result item while still online, the Web page will be retrieved from an online server and presented to the user, but will also be stored as a separate entry in association with its URL. But as described above, there may be no external or explicit indication stored that associates the JSON record with the stored Web page. The JSON record includes the Web page URL, and the Web page can be identified within the cache based on its URL. Thus, when the mobile device is offline and the user selects the stored search query, the local cache is searched based on the search query URL, and the JSON record is located on that basis. The JSON record is fetched from the cache and rendered. When the Web page URL is encountered in the JSON record, the local cache is searched based on the image URL, and the Web page is located within the cache and fetched. Note that in one embodiment, it is a screenshot of the Web page, not the actual content of the Web page, which is stored in the local cache. In another embodiment, the actual content of the Web page is stored.

When a cache entry is deleted from the cache on an LRU basis, there is no need to track down all of the entries related to the deleted entry, because the LRU technique automatically ensures that the associated entries will be deleted over time. When a JSON record is received from a search engine, it is stored in cache before any associated data, such as images, are stored. This ensures that the JSON record has an older access date than the associated entries. Similarly, when a stored JSON entry is accessed and rendered, the associated entries are accessed after the JSON record is accessed, again resulting in the JSON record having an older access data than the associated entries. Thus, a JSON record will always end up being deleted before any of its associated entries. And once the JSON record (which contains the references to the associated entries) has been deleted, the associated entries will no longer be accessed and will thus end up having the oldest access dates in the cache, resulting in their eventual deletion.

Stated another way, suppose that to render the search results for a particular search query, records A, B, C, D, and E are needed. Record A “knows” that it needs records B, C, D, and E. When the data is stored, there is no need to store the fact that B, C, D, and E are related to A. That relationship is not part of the data structure, but rather is contained in record A. When record A is rendered, because record A knows that it needs records B, C, D, and E, those associated records are fetched and rendered with no need to have the relationship stored eternally or separately. This provides an advantage of simplifying the record architecture and the design of the local cache. Additionally, because record A will load first, and record A knows that it needs B, C, D, and E, it is always true that record A will be fetched first, and then B, C, D, and E. Thus, records B, C, D, and E will always have a more recent access date than record A. When the LRU cache management is performed, record A has the oldest time stamp of records A, B, C, D, and E. Once record A has been deleted, the content of B, C, D, and E will no longer be available to the app, i.e., records B, C, D, and E are orphaned. They are never used anywhere else, and so end up with the oldest time stamps, and in the order of deletion, they will be the next to be deleted.

The cached content may be refreshed in the background to keep the content current. In an embodiment, a low-priority thread is spun off in the background iterating through the cache, retrieving the latest online content based on the URL (stored in the cache), assuming the mobile device is online. That way any element retrieved by the user from the cache during the offline mode will contain the most up-to-date version of the content possible. In one embodiment, the background refresh operation may be enabled or disabled based on a user preference. The refresh may be enabled or disabled globally or on an item-by-item basis.

In a first aspect, a method is provided for accessing search results while offline. A search query is received via an input component of a mobile device while a connection to a network is available. The search query is submitted, by way of a wireless communication component of the mobile device, via the network to an online search engine. Search result items are received from the search engine, by way of the wireless communication component of the mobile device, via the network. The search result items are presented on an output component of the mobile device. The search query and the search result items are stored in a persistent local memory storage component of the mobile device that is accessible when the mobile device is offline. The same search query is received via the input component of the mobile device while the connection to the network is unavailable. The search result items associated with the search query are received from the persistent local memory storage component of the mobile device, and the search result items are presented on the output component of the mobile device while the connection to the network is unavailable.

In a second aspect, computer-readable media are provided for accessing search results while offline. A search query is received while in an online mode. The search query is submitted to an online search engine. Search result items are received from the search engine. The search result items are presented. The search query and the search result items are stored in a local data storage that is accessible offline. The search query is received while in an offline mode. The search result items associated with the search query are retrieved from the local storage, and the list of search result items is presented.

In a third aspect, a system is provided for accessing search results while offline. The system includes a local data storage, an output device, an input device, and one or more processors. The one or more processors are configured to receive a search query via the input device, determine that an online connection is unavailable, determine whether the search query is stored in the local data storage, when the search query is stored in the local data storage, then retrieve, from the local data storage, a search result that is stored in association with the search query, and present the search result on the output device

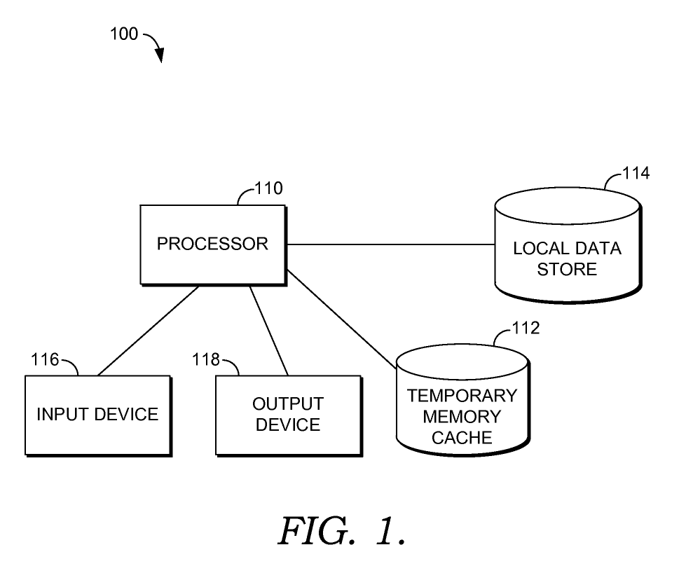

Referring to FIG. 1, a system for accessing search results in an offline mode is depicted, and is generally referred to as system 100. System 100 is but one example of a suitable system and is not intended to suggest any limitation as to the scope of use or functionality of embodiments of the invention. Neither should system 100 be interpreted as having any dependency or requirement relating to any one or combination of components illustrated.

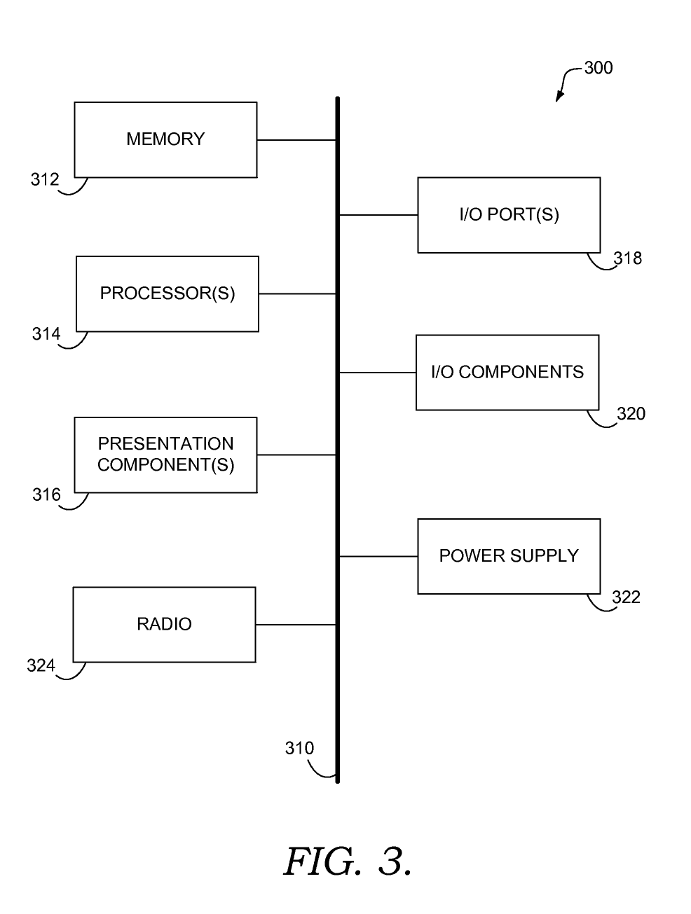

System 100 includes a processor 110, a temporary memory cache 112, a persistent local data store 114, an input device 116, and an output device 118. Processor 110 may be a device similar to processor 314 described below with reference to FIG. 3. Although depicted as a single processor, in some embodiments processor 110 may include one or more devices and/or processors. In an embodiment, temporary memory cache 112 is utilized by a search app for storing data that is processed while the search app is running, whereas local data store 114 is configured to store data from the search app which persists even after the search app has terminated. In an embodiment, local data store 114 is configured to persistently store search queries that are submitted to an online search engine, as well as the associated search results received from the online search engine.

In an embodiment, processor 110 executes the search app. i.e., executes computer-usable instructions which make up the search app. The computer-usable instructions may be embodied on one or more computer-readable media. In an embodiment, when executing the computer-usable instructions, processor 110 is configured to receive a search query by way of input device 116. For example, the search query may be received via a user interface such as a keypad, touchscreen, and/or an audio input. Processor 110 may determine whether the search query and its associated search results are already stored in temporary memory cache 112. For example, the same search query may have been previously received during the current search session and the search results already obtained, with the search query and results remaining in temporary memory cache 112 during the session. If the search query is then received a second time, and the search query and search results are still in memory cache 112, then the search results may be retrieved from memory cache 112 and presented to the user via output device 118. However, in an embodiment, memory cache 112 exists only while the search app is running. When the search app is terminated, all data in memory cache 112 is lost.

It may be that the search query and the search results are not stored in temporary memory cache 112. In an embodiment, processor 110 is configured to then determine whether a network connection is available. In one embodiment, processor 110 determines whether a network connection is available by attempting to submit the search query to an online search engine server, in which case a failure response indicates that an online connection is not available. In another embodiment, processor 110 determines whether a network connection is available based on a stored status indication of a network connection. If a network connection is available, the search query is communicated to the online search engine server and search results are received from the search engine server. The search results may then be presented to the user via output device 118. In an embodiment, processor 110 is further configured to determine whether local data store 114 already includes a record containing the search query. If so, then processor 110 updates the record with the current associated search results received from the server. But if local data store 114 does not already include a record containing the search query, then processor 110 creates a record and stores the search query and the associated search results in local data store 114.

Upon receiving the search query, if the search query and the search results are not already stored in memory cache 112, and if processor 110 determines that a network connection is not available, in an embodiment processor 110 is configured to determine whether the search query is stored in local data store 114. Unlike memory cache 112, in an embodiment local data store 114 is configured to retain data even after the search app is terminated. If the search query is stored in local data store 114, then processor 110 retrieves search results from local data store 114 which are associated with the stored search query and presents the search results to the user via output device 118, just as if the search results had been retrieved from the online search engine. An indication may be presented to the user that the search results are being viewed in offline mode. If the search query is not stored in local data store 114, processor 110 may be configured to display an error message or other notification to the user that the search results are not available in offline mode.

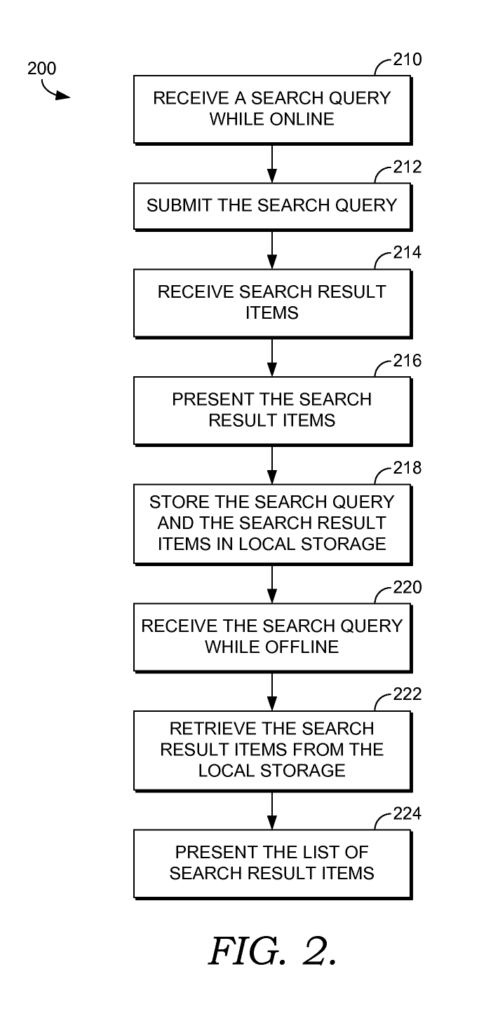

Referring to FIG. 2, a method for accessing search results in an offline mode is depicted, and is generally referred to as method 200. Method 200 is but one example of a suitable method and is not intended to suggest any limitation as to the scope of use or functionality of embodiments of the invention. Neither should method 200 be interpreted as having any dependency or requirement relating to any one or combination of components illustrated.

In an embodiment, a mobile device executes a search app which enables a user to enter a search query and view search results received form an online search engine. The search app may utilize online API calls to submit search queries to an online search API. At a step 210, a user search query is received while in an online mode, i.e., when a network connection is available. For example, the user search query may be received via a user interface on the mobile device or other device which may be similar to computing device 300 described below with regard to FIG. 3. The mobile device may determine that a network connection, such as with the Internet, is available. At a step 212, the search query is submitted over the network to an online search engine. In an embodiment, submitting the search query is accomplished by converting the search query into an API call having the form of a URL, then submitting the URL to a search engine server. At a step 214, a list of search result items is received from the search engine via the network. In an embodiment, the search results are received in the form of a JSON payload.

At a step 216, the list of search result items is presented to the user on the mobile device's user interface. At a step 218, the search query and the list of search result items are stored in a persistent offline memory storage, such as a persistent local memory on the mobile device. The search query and the list of search result items may be stored while the list of search result items is being presented to the user, by means of a lower-priority background thread so as not to interfere with presentation of the search results. In an embodiment, the search query is stored as a normalized URL. The URL initially submitted to the search engine server may contain parameters such as location information, time stamp, and so forth. Any parameters that are not needed to uniquely identify the search query may be stripped from the URL, thus providing the normalized URL. URLs contained within the search results, for example, URLs of Web pages, images, and so forth, may also be converted to normalized URLs before storing the search results in the local memory storage. In one embodiment, the query is altered to reflect a user intent before being sent to the search engine and/or stored in the local memory storage. For example, the actual user query could be “Taj Mahal,” but based on information such as a user profile, user preferences, past search history, or other data, a determination may be made that the user is searching for a restaurant rather than a mausoleum. The query may then be modified to “Taj Mahal restaurant” prior to being submitted/stored.

In an embodiment, prior to storing the search query, a determination is made as to whether a record associated with the search query already exists in the local memory storage. When the record exists, then the local memory storage is updated with the received search results. When the record does not exist, then a new record associated with the search query is created in the local memory storage and the search query and the received search results are stored in the persistent local memory storage.

In an embodiment, when the mobile device is online and presents the search result items to the user, if the user selects a search result item from the presented search results, then the online content of the selected search result is presented to the user, and the content of the selected search result is also stored in the local memory storage. For example, the list of search result items may include one or more URLs pointing to Web pages. When the user selects one of the URLs, then the Web page is presented to the user, and the content of the Web page is stored in the local memory storage in association with its corresponding URL. The URL in this instance may also be normalized as described above. In an embodiment, storing the content of the selected search result is accomplished by storing a screenshot of the content, for example, a screenshot of a Web page. In one embodiment, storing the content of the selected search result is accomplished by storing the actual content itself, such as storing the actual content of a Web page, e.g., text and so forth. In an embodiment, storing the search results includes storing the search results in a local cache and determining the size of the local cache. When the size of the local cache exceeds a threshold size, then one or more least-recently-used records is deleted from the local cache until the size of the local cache is within the threshold size.

At a step 220, the same search query is received while in an offline mode, i.e., when a connection to a network is not available. For example, the user may have traveled to a location where no Internet connection is available. In that event, the search query cannot be submitted to an online search engine. In one embodiment, the search query is received as a selection from a list of previously-stored search queries that may be presented to the user while in offline mode. For example, the stored queries may appear in a drop-down list in response to the user typing in, or otherwise accessing, a search entry field. The stored queries may be presented as suggested queries as the user types. The search query is then received upon a selection by the user. Alternatively, the user may type the search query into a search entry field without selecting a stored query. In that event, the typed query may or may not have already been stored in the local memory storage.

In an embodiment, upon receiving the search query, the mobile device determines whether the received search query is stored in the local memory storage. The search query may be converted to a normalized URL, and the local memory storage searched for the presence of the same normalized URL. If the normalized URL is found in the local memory storage, then at step 222, the list of search result items associated with the search query is retrieved from the local memory storage. At a step 224, the list of search result items is presented to the user on the mobile device. When the received query is not stored in the local memory storage, then a message may be presented to the user to indicate that the device is offline and/or the search results are not available.

Referring to FIG. 3, an exemplary operating environment suitable for implementing an embodiment of the present invention is shown and designated generally as computing device 300. Computing device 300 is but one example of a suitable computing environment and is not intended to suggest any limitation as to the scope of use or functionality of embodiments of the invention. Neither should computing device 300 be interpreted as having any dependency or requirement relating to any one or combination of components illustrated.

Some embodiments of the invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. Some embodiments of the invention may be practiced in a variety of system configurations, including hand-held devices, consumer electronics, general-purpose computers, more specialty computing devices, etc. Some embodiments of the invention may also be practiced in distributed computing environments where tasks are performed by remote-processing devices that are linked through a communications network.

With reference to FIG. 3, computing device 300 includes a bus 310 that directly or indirectly couples the following devices: memory 312, one or more processors 314, one or more presentation components 316, input/output ports 318, input/output components 320, and an illustrative power supply 322. Bus 310 represents what may be one or more busses (such as an address bus, data bus, or combination thereof). Although the various blocks of FIG. 3 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. We recognize that such is the nature of the art, and reiterate that the diagram of FIG. 3 is merely illustrative of an exemplary computing device that can be used in connection with one or more embodiments of the present invention. Distinction is not made between such categories as “workstation,” “server,” “laptop,” “hand-held device,” and so forth, as all are contemplated within the scope of FIG. 3 and reference to “computing device.”

Computing device 300 typically includes a variety of computer-readable media. By way of example, and not limitation, computer-readable media may comprise Random Access Memory (RAM); Read Only Memory (ROM); Electronically Erasable Programmable Read Only Memory (EEPROM); flash memory or other memory technologies; CDROM, digital versatile disks (DVD) or other optical or holographic media; magnetic cassettes, magnetic tape, magnetic disk storage, other magnetic storage devices, or other medium that can be used to encode desired information and be accessed by computing device 300. As used herein, computer-readable media do not include signals per se.

Memory 312 includes computer-storage media in the form of volatile and/or nonvolatile memory. The memory may be removable, nonremovable, or a combination thereof. Exemplary hardware memory devices include solid-state memory, hard drives, optical-disc drives, and such like. Computing device 300 includes one or more processors that read data from various entities such as memory 312 or I/O components 320. Presentation component(s) 316 present data indications to a user or other device. Exemplary presentation components include a display device, speaker, printing component, vibrating component, etc.

I/O ports 318 allow computing device 300 to be logically coupled to other devices including I/O components 320, some of which may be built in. Illustrative components include a microphone, joystick, game pad, satellite dish, scanner, printer, wireless device, etc.

Radio 324 represents a radio that facilitates communication with a wireless telecommunications network. Illustrative wireless telecommunications technologies include CDMA, GPRS, TDMA, GSM, and the like. In some embodiments, radio 324 might also facilitate other types of wireless communications including Wi-Fi communications and GIS communications.

Many different arrangements of the various components depicted, as well as components not shown, are possible without departing from the scope of the claims below. Embodiments of our technology have been described with the intent to be illustrative rather than restrictive. Alternative embodiments will become apparent readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims.

The invention claimed is:

1. A method of accessing search results while offline, comprising:
submitting a search query, by way of a wireless communication component of a mobile device, via a network to an online search engine;
receiving search result items from the search engine, by way of the wireless communication component of the mobile device, via the network;
storing the search query and the search result items in a persistent local memory storage on the mobile device;
receiving the search query via the input component of the mobile device while the connection to the network is unavailable;
retrieving the search result items associated with the search query from the persistent local memory storage on the mobile device; and
presenting the retrieved search result items on the output component of the mobile device while the connection to the network is unavailable.

2. The method of claim 1, wherein storing the search result items comprises:
determining whether a record associated with the search query exists in the persistent local memory storage;
when the record exists, then updating the persistent local memory storage with the search result items; and
when the record does not exist, then
A) creating a new record in the persistent local memory storage associated with the search query, and
B) storing the received search result items in the persistent local memory storage.

3. The method of claim 1, the method further comprising:
while the connection to the network is available, presenting the search result items on an output component of the mobile device;
receiving a user selection of a search result item from the presented search result items;
presenting a content of the search result item on the output component of the mobile device; and
storing the content of the search result item in the persistent local memory storage.

4. The method of claim 3, wherein storing the content of the search result item in the persistent local memory storage includes storing the URL of the search result item in association with the content of the search result item.

5. The method of claim 3, wherein storing the content of the search result item comprises storing a screenshot of the content.

6. The method of claim 1, wherein storing the search result items comprises:
storing the search result items in a local cache of search results;
determining a size of the local cache; and
when the size of the local cache exceeds a threshold size, then deleting from the local cache one or more least-recently-used records until the size of the local cache is within the threshold size.

7. The method of claim 1, wherein receiving the search query while the connection to the network is not available comprises:
presenting, on the output component of the mobile device, one or more stored search queries including the search query; and
receiving a user selection of the search query from the one or more stored search queries.

8. One or more computer-readable media having embodied thereon computer-usable instructions which, when executed, perform a method of accessing search results while offline, the method comprising:
receiving a search query while in an online mode;
submitting the search query to an online search engine;
receiving search result items from the search engine;
presenting the search result items;
storing the search query and the search result items in a local storage;
receiving the search query while in an offline mode;
retrieving the search result items associated with the search query from the local storage; and
presenting the search result items.

9. The media of claim 8, wherein storing the search result items comprises:
determining whether a record associated with the search query exists in the local storage;
when the record exists, then updating the local storage with the received search result items; and
when the record does not exist, then
A) creating a new record in the local storage associated with the search query, and
B) storing the received search result items in the local storage.

10. The media of claim 8, the method further comprising:
while in the online mode, receiving a user selection of a search result item from the presented search result items;
presenting a content of the search result item; and
storing the content of the search result item in the local storage.

11. The media of claim 10, wherein storing the content of the search result item in the local storage includes storing the URL of the search result item in association with the content of the search result item.

12. The media of claim 10, wherein storing the content of the search result item comprises storing a screenshot of the content.

13. The media of claim 8, wherein storing the search result items comprises:
storing the search result items in a local cache of search results;
determining a size of the local cache; and
when the size of the local cache exceeds a threshold size, then deleting from the local cache one or more least-recently-used records until the size of the local cache is within the threshold size.

14. The media of claim 8, wherein receiving the search query while in the offline mode comprises:
presenting one or more stored search queries including the search query; and
receiving a user selection of the search query from the one or more stored search queries.

15. A system for accessing search results while offline, comprising:
a local data storage;
an output device;
an input device;
one or more processors configured to
A) receive a search query via the input device,
B) determine that an online connection is unavailable,
C) determine whether the search query is stored in the local data sto rage,
D) when the search query is stored in the local data storage, then retrieve, from the local data storage, a search result that is stored in association with the search query, and
E) present the search result on the output device.

16. The system of claim 15, wherein the one or more processors are further configured to:
initially receive the search query while the online connection is available;
submit the search query to an online search engine;
receive the search result from the search engine;
present search result; and
store the search query and the search result in the local data storage.

17. The system of claim 16, wherein store the search query and the search result in the local data storage comprises:
determine whether a record associated with the search query exists in the local data storage;
when the record exists, then update the local data storage with the received search result; and
when the record does not exist, then
A) create a new record in the local data storage associated with the search query, and
B) store the received search result in the local data storage.

18. The system of claim 15, wherein the one or more processors are further configured to:
while the online connection is available, receive a user selection of the search result;
in response to the user selection of the search result, present a content of the search result; and
store the content of the search result in the local data storage.

19. The system of claim 18, wherein the URL of the selected search result is stored in association with the stored content of the selected search result.

20. The system of claim 16, wherein store the search query and the search result in the local data storage comprises:
determine a size of the local data storage including the search query and the search result; and
when the size of the local data storage including the search query and the search result exceeds a threshold size, then delete from the local data storage one or more least-recently-used records until the size of the local data storage including the search query and the search result is within the threshold size.
